(19) United States
(12) Patent Application Publication
(10) Pub. No.: US 2007/0157255 A1
(43) Pub. Date: Jul. 5, 2007

(54) Audiovisual Console Control Interface

(76) Inventor: Aki Kitazawa, Torrance, CA (US)

Correspondence Address: MICHAEL BLAINE BROOKS, P.C., P.O. BOX 1630, SIMI VALLEY, CA, 93062-1630, US

(21) Appl. No.: 11/616,432

(22) Filed: Dec. 27, 2006

Related U.S. Application Data
(60) Provisional application No. 60/756,033, filed on Jan. 3, 2006.

(51) Int. Cl. H04N 7/18

(52) U.S. Cl. 725/75; 725/77

(57) ABSTRACT

The invention, in its several embodiments, pertains to audiovisual consoles, more particularly to audiovisual consoles for use in cars. In some embodiments, a device is provided that includes a control user interface and a play user interface, wherein the control user interface is adapted to receive inputs to define a first list of audiovisual elements from which a user, via the play user interface, may select to play on a presentation device.

### CROSS-REFERENCE TO RELATED APPLICATIONS

This application claims the benefit of U.S. Provisional Patent Application Ser. No. 60/756,033 filed Jan. 3, 2006, entitled “Audiovisual Console Control Interface,” which is hereby incorporated by reference herein for all purposes.

### FIELD OF THE INVENTION

The invention, in its several embodiments, pertains to audiovisual consoles, more particularly to audiovisual consoles for use in cars.

### BACKGROUND

Audiovisual devices, such as digital versatile or video disc (DVD) players, in vehicles are currently available. Furthermore, the capacity of digital media storage has greatly increased such that certain media devices are adapted to store a large amount of data, such as multiple movies or shows. A way to integrate these digital media storage devices with audiovisual devices in vehicles is highly desirable. Furthermore, a device adapted to enable a driver parent, for example, to determine which movies a child, for example, in a back seat may watch is also highly desirable.

### SUMMARY

In one aspect, a device for a vehicle is provided. This device includes a control user interface, a play user interface, and a presentation device. The control user interface and the play user interface are operably connected with each other. Furthermore, the control user interface includes a display and one or more effectors. The display is adapted to display a first list of audiovisual elements, and the one or more effectors is adapted to receive one or more user input to generate a second list of audiovisual elements comprising one or more audiovisual elements from the first list. The play interface includes one or more input effectors adapted to receive a selection to play an audiovisual element from the second list. The presentation device is adapted to play the selected audiovisual element.

In another aspect, a system is provided. This system includes a vehicle and a device mounted in an interior of the vehicle. The device includes a control user interface, a play user interface, and a presentation device, wherein the control user interface and the play user interface are operably connected with each other. The control user interface includes a display adapted to display a first list of audiovisual elements and one or more effectors adapted to receive one or more user input to generate a second list of audiovisual elements comprising one or more audiovisual elements from the first list. The play user interface includes one or more input effectors adapted to receive a selection to play an audiovisual element from the second list. The presentation device is adapted to play the selected audiovisual element.

### BRIEF DESCRIPTION OF THE DRAWINGS

The present invention is illustrated by way of example and not limitation in the figures of the accompanying drawings, and in which:

FIG. 1 is a high-level diagram of an exemplary audiovisual console in plan view, according to an embodiment of the invention;

FIG. 2 is a high-level diagram of another exemplary audiovisual console in a side view, according to an embodiment of the invention;

FIG. 3 is a high-level diagram of an exemplary mounting location of an exemplary embodiment of the audiovisual console in a vehicle, according to an embodiment of the invention;

FIG. 4 is a high-level diagram of another exemplary mounting location of an exemplary embodiment of the audiovisual console in a vehicle, according to an embodiment of the invention;

FIG. 5 is a high-level diagram of an exemplary audiovisual console with various input effectors, according to an embodiment of the invention;

FIG. 6 is a high-level diagram of another exemplary audiovisual console with various input effectors, according to an embodiment of the invention;

FIG. 7 is a high-level diagram of an exemplary embodiment of the hierarchy of file control between two user interfaces, according to an embodiment of the invention;

FIG. 8 is a high-level diagram of another exemplary audiovisual console with a removable interface module, according to an embodiment of the invention;

FIG. 9 is a high-level diagram in perspective view of an exemplary hinged receiver adapted to receive the exemplary removable interface module of FIG. 8, according to an embodiment of the invention;

FIG. 10 is a high-level diagram in a side view of an exemplary audiovisual console having a DVD audiovisual console, according to an embodiment of the invention;

FIG. 11 is a high-level diagram in plan view of an exemplary power and signal interface to which a docked removable interface module and a DVD audiovisual console may be operably connected, according to an embodiment of the invention;

FIG. 12 is a high-level diagram of an audiovisual console with an exemplary power/signal interface, according to an embodiment of the invention; and

FIG. 13 is a schematic view of an exemplary system configuration, according to an embodiment of the invention.

### DETAILED DESCRIPTION OF THE INVENTION

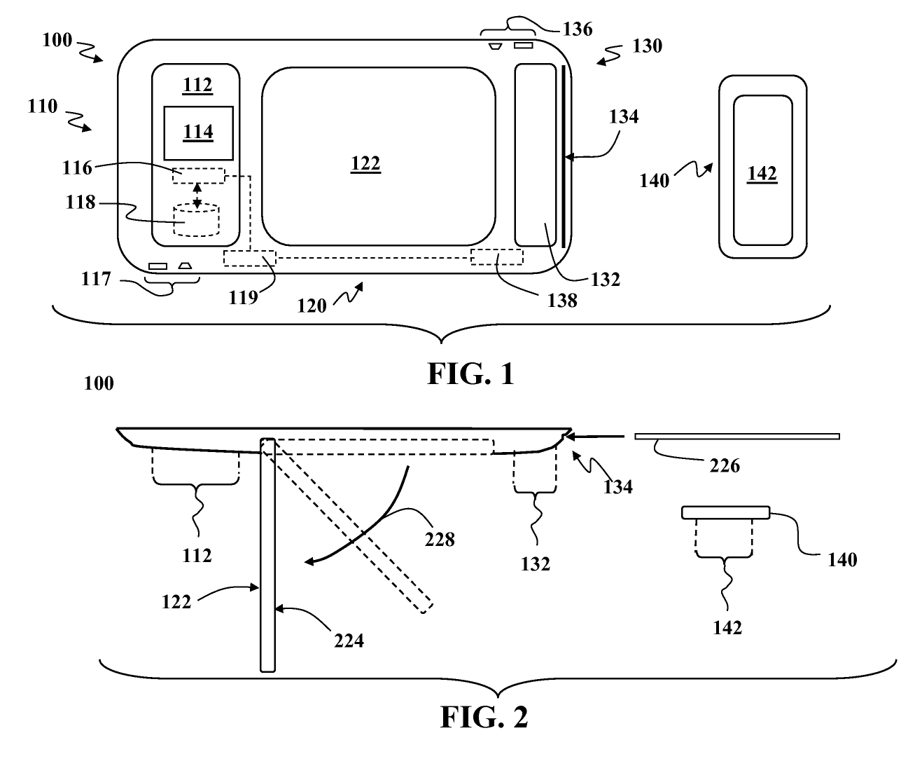

An exemplary audiovisual console 100 is illustrated in plan view in FIG. 1 and may be described for purposes of exemplary orientation as having a forward portion 110, a mid-body portion 120, and an aft portion 130. In this example, the mid-body portion 120 includes a video screen (not shown) having an exterior surface 122. The aft portion 130 may include a region or first user interface 132, of one or more user input effectors, such as buttons, toggles, sliders, and touch pads. The first user interface is herein also referred to as a play user interface. The aft region or portion 130 may also include an interface 134, such as an aperture and internal tray (not shown), for receiving, reading, and ejecting a media-bearing article or data store, such as a DVD. In addition, the aft portion 130 may also include external input ports 136, for example, digital media ports such as an IEEE 1394 port and one or more universal serial bus (USB) ports. The exemplary audiovisual console 100 may be operably connected, for example, by way of an optical or an RF link, to a remote control unit 140 having a region, or second user interface 142, of one or more user input effectors, such as buttons, toggles, sliders, or touch pads. The forward portion 110 may include a region or third user interface 112 of one or more user input effectors, such as buttons, toggles, sliders, touch pads, and a display. The third user interface 112, also herein referred to as a control user interface, may further include a display or screen 114, which may include touch screens, for displaying audiovisual elements, such as audiovisual files or portions thereof, and where, for example, the third user interface 112 may receive user input for selecting a displayed audiovisual element, e.g., file, for play. Input commands entered via the third user interface 112 may be processed by a processing unit or module 116 which may store to and retrieve files from a data store 118. In addition, the forward portion 110 may also include external input ports 117, for example, digital media ports such as an IEEE 1394 port and one or more universal serial bus (USB) ports. These external input ports 117, 136 may be adapted to operably attach other media-bearing articles, for example, thumb drives to the audiovisual console 100. Some embodiments of the audiovisual console 100 may process input commands from the first user interface 132 and input commands from the third user interface 112 via one or more integrated processing modules 138 and in some embodiments of the audiovisual console 100 may process input commands from the first user interface 132 via a first signal processing module 138 and input commands from the third user interface 112 via a second signal processing module 116, where the signals may interface via an interface module 119.

Illustrated in a side view in FIG. 2, the exemplary audiovisual console is shown having a screen or a presentation unit 224 that may be positioned or deployed 228 into an aft-facing direction for viewing. The first user interface 132 may control the viewing of an inserted media-bearing article 226. In embodiments where the audiovisual console 100 may have a second user interface integral 142 to a remote controller 140, the second user interface 142 may allow the user to control, for example, via push buttons or other effectors, the view of the inserted media-bearing article. The third user interface 112 may allow, for example by push buttons or other effectors, the user control of the play of the inserted media-bearing article 226 and allow the user to designate and control the play of auxiliary audio/video sources (not shown).

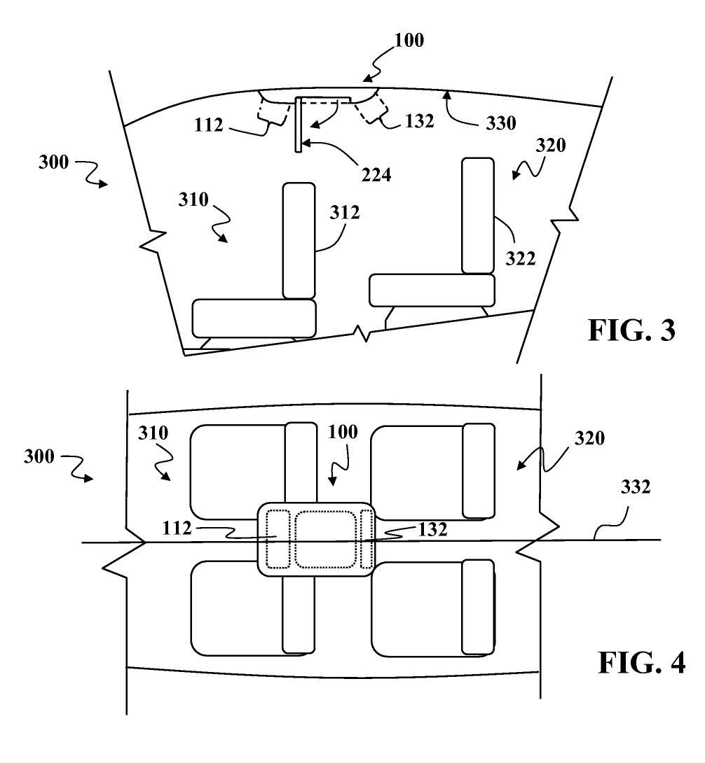

Illustrated in a side view in FIG. 3 is an exemplary mounting location of an exemplary embodiment of the audiovisual console 100 shown in a cab volume 300 of a vehicle having a forward seating position 310 and an aft seating position 320. In this example, the audiovisual console 100 is positioned proximate to the ceiling 330 of the cab 300 and the seatback 312 of the forward seating position 310. Illustrated in a top view in FIG. 4 is the exemplary mounting location shown in this example as being mounted along a longitudinal axis of symmetry 332 of the vehicle.

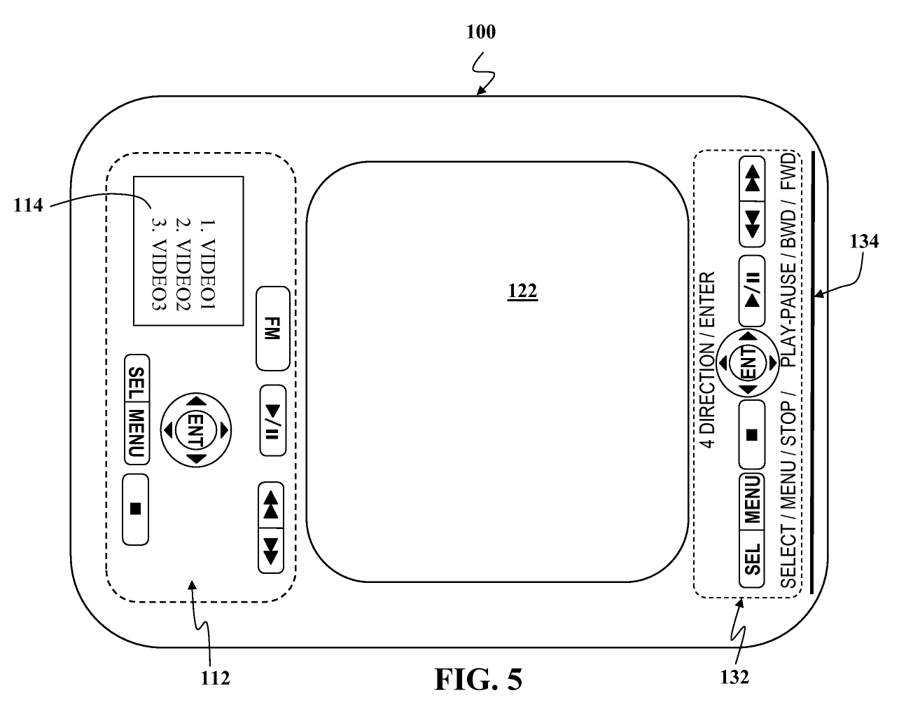

Illustrated in a plan view in FIG. 5 is an exemplary embodiment of the audiovisual console 100 where the first user interface 132, by way of example, comprises a select/menu rocker button, a stop button, a four-direction wheel with an enter button, a play/pause push button and a fast forward-skip forward/reverse-skip forward rocker button. In this example, the third user interface 112 comprises a select/menu rocker button, a stop button, a four-direction wheel with an enter button, a play/pause push button, a fast forward-skip forward/reverse-skip forward rocker button and an optional FM radio mode select button. In addition, the third user interface 112 in this example comprises a display 114 listing, e.g., video files from which the user may select and play.

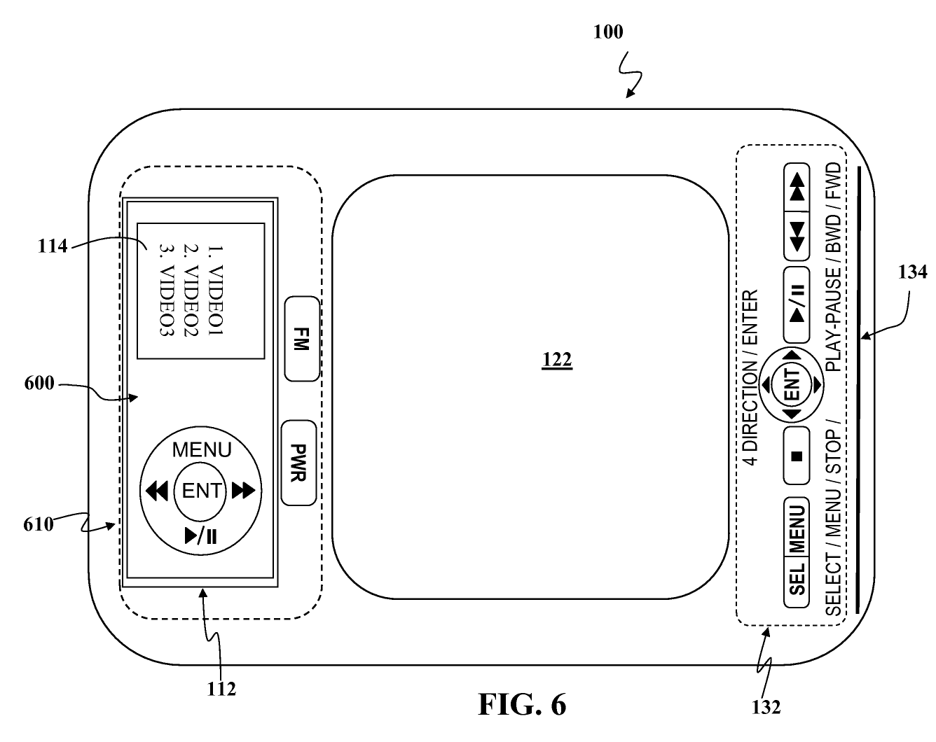

Illustrated in a plan view in FIG. 6 is an exemplary embodiment of the audiovisual console 100 where the third user interface 112 comprises an optional FM radio mode select button and a power on/off push button, and further comprises a module 600 having a display 114, listing in this example, video files from which the user may select and play, e.g., via a combination touchpad 610 having a four-way wheel pushbutton with an enter pushbutton. Some embodiments of the third user interface 112 have a pressure-sensitive or other touch screen where the file folder and file selection may be effected via a stylus, for example. The audio-visual files may be arranged within one or more file folders wherein the user may select via the third user interface, for example, the user may scroll through the folders using the touchpad, and select via the enter button, a file folder from which those designated as permitted viewing may be subsequently selected and controlled via the first user interface or the second user interface.

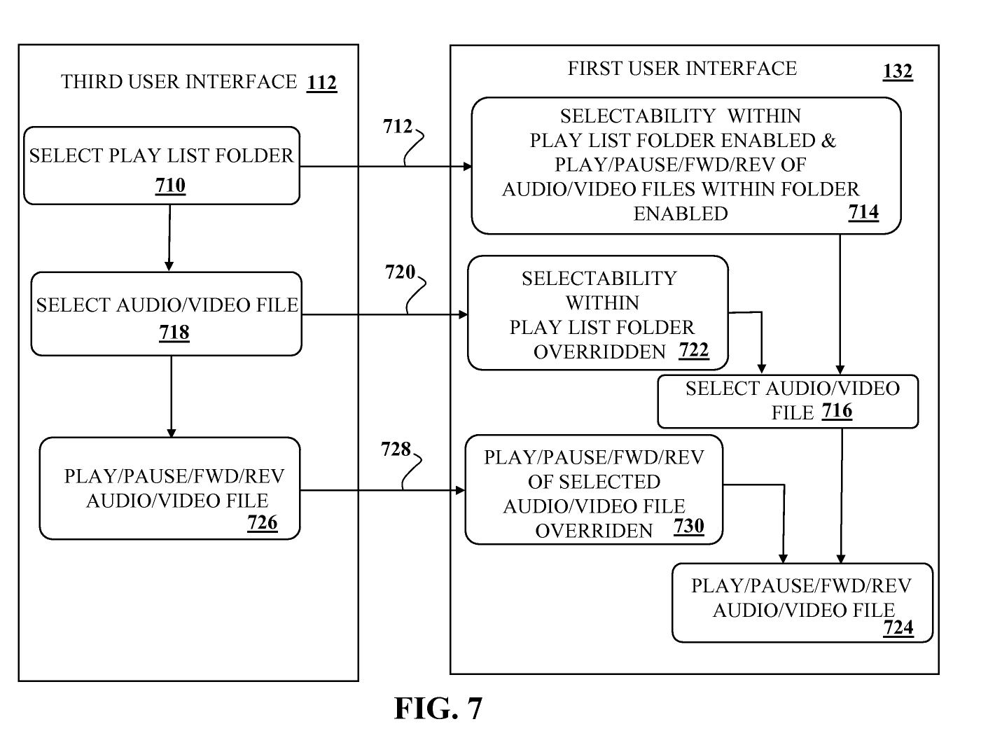

An exemplary embodiment of the hierarchy of file control between two user interfaces is illustrated in FIG. 7. Once the audiovisual media article is inserted into the audiovisual console and read and displayed at the contents of chapters, file folder or play list level, the user, via the third user interface 112, may select a play list of audiovisual elements, particular video chapter range, or file folder (step 710). The first user interface 132 may default to allowing user play list selections only within one or more selection-enabled play list folders. This selection (step 710) may be made available via a signal path 712 to the first user interface 132 by way a signal interface (not shown) and may affect the first user interface 132 by enabling selectability within the enabled play list folder 714. A user, via a first user interface 132, may select (step 716) an audio/video file from within the play list selected (step 710) via the third user interface 112. The first user interface 132 may default to allowing user play list selections only within one or more selection-enabled play list folders and only when an audio/video file has not been selected via the third user interface 112. A user, via the third user interface 112, may select from with the selected play list folder an audio/video element, e.g., file (step 718). This selection step 718 may be made available via a signal path 720 to the first user interface 132 by way of a signal interface (not shown) and may affect the first user interface 132 by overriding the present audio/video file selection (step 722) via the first user interface 132, if any, and disabling further selection of audio/video files via the first user interface 132 until reset, for example, by the selection of a different play list folder to a restart of the audiovisual console 100. The first user interface 132 may default to allowing user play control such as play, pause, fast forward, and reverse only when one or more play control operations have not been selected via the third user interface 112 and accordingly, a user may effect a play control operation (step 724) via the third user interface 112. A user, via the third user interface 112, may effect a play control operation (step 726). This selection step 726 may be made available via a signal path 728 to the first user interface 132 by way of a signal interface (not shown) and may affect the first user interface 132 by overriding the present play control operation (step 730) via the first user interface 132, if any, and disabling further play control operation selection via the first user interface 132 until reset, for example, by the selection of a different play list folder to a restart of the audiovisual console 100. Some embodiments of the second user interface 142 of a remote control unit 140 (FIGS. 1 and 2), may combine the play list selection function of the third user interface 112 and the media play control of the first user interface 132. When invoked, input signals received by the audiovisual console 100 from the remote control unit having play list selection commands may take precedent over commands and selections via the third user interface 112 and the second user interface 142.

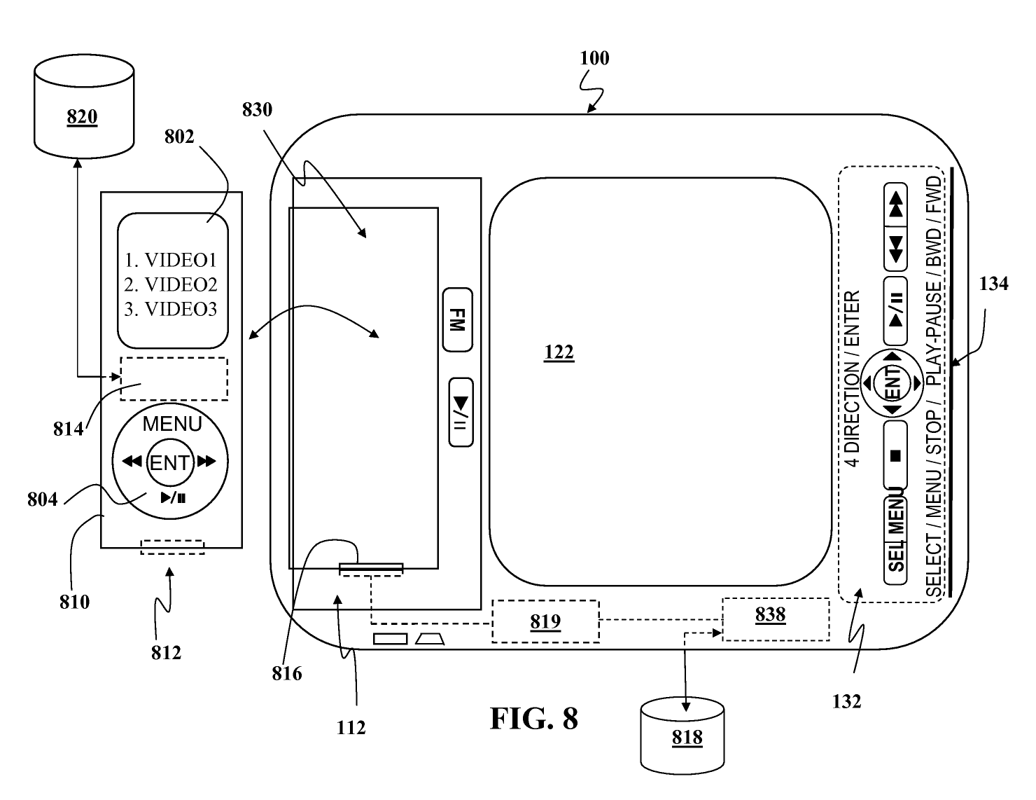

Illustrated in a plan view in FIG. 8 is an exemplary embodiment of the audiovisual console 100 where the third user interface 112 comprises a play/pause push button and an optional FM radio mode select button, and further comprises a removable interface module 810 having a display 802, a combined touchpad and four-way wheel pushbutton with an enter pushbutton 804 and a processing module 814 for output to display and audio output ports to process audiovisual files. The third user interface 112 may further comprise a recessed receiving cradle 830 for receiving and securing the removable interface module 810. The removable interface module 810 may include an audiovisual store 820 where audiovisual signals output by the processing module 814 of the removable interface module 810—as drawn from the audiovisual store 820—may be directed to the audiovisual display 224 (FIG. 3) of the audiovisual console 100 via an auxiliary channel. In addition, the removable interface module 810 may have a first signal/power connector 812 that may receive a second signal/power connector 816 of the third user interface 112 or the recessed receiving cradle 830. The removable interface module 810 may be a removable interface device that may display files and folders retrieved from its audio-visual store whether docked with the console or not. When docked, the removable interface device 810 may receive control input to display, via the audiovisual console display 224 (FIG. 3), files and file folders, and the docked removable interface device 810, via a signal interface 819 between the second signal/power connector 816 and the audiovisual console processing module 838, may provide an input interface to control the play of the selected files of the audiovisual store or chapters of an inserted article of conveyance of audiovisual media, such as a DVD or files and folders retrieved by the audiovisual console processing module 838 from the audiovisual console data store 818.

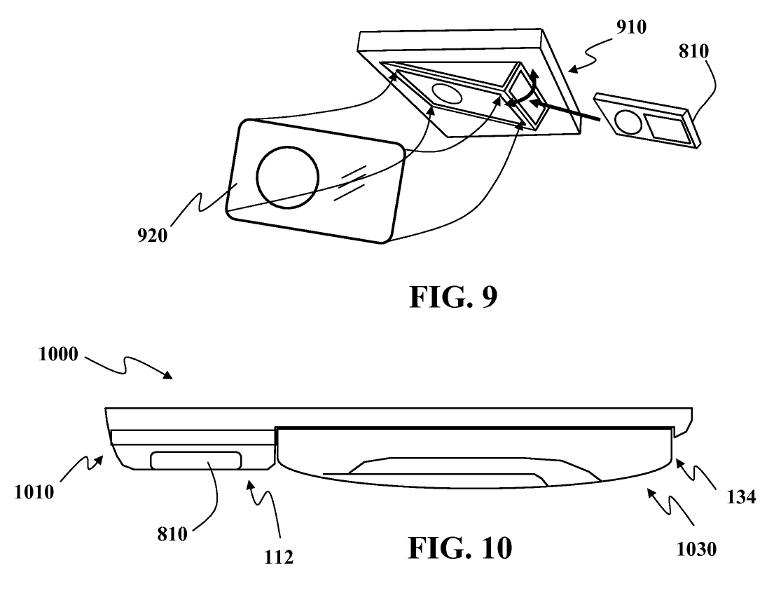

Illustrated in perspective view in FIG. 9 is an exemplary hinged receiver 910 for an exemplary removable interface module 810. A protective transparent cover 920 may be integrated to one side of the exemplary hinged receiver 910.

Illustrated in a side view in FIG. 10 is an exemplary audiovisual console 1000 having a DVD audiovisual console 1030, as an example of an audiovisual console that receives and plays an inserted article of conveyance of audiovisual media, such as a DVD, that may be operably coupled to a mounting module 1010, where, in this example, the mounting module 1010 includes the third user interface 112 and particularly includes a removable interface module 810.

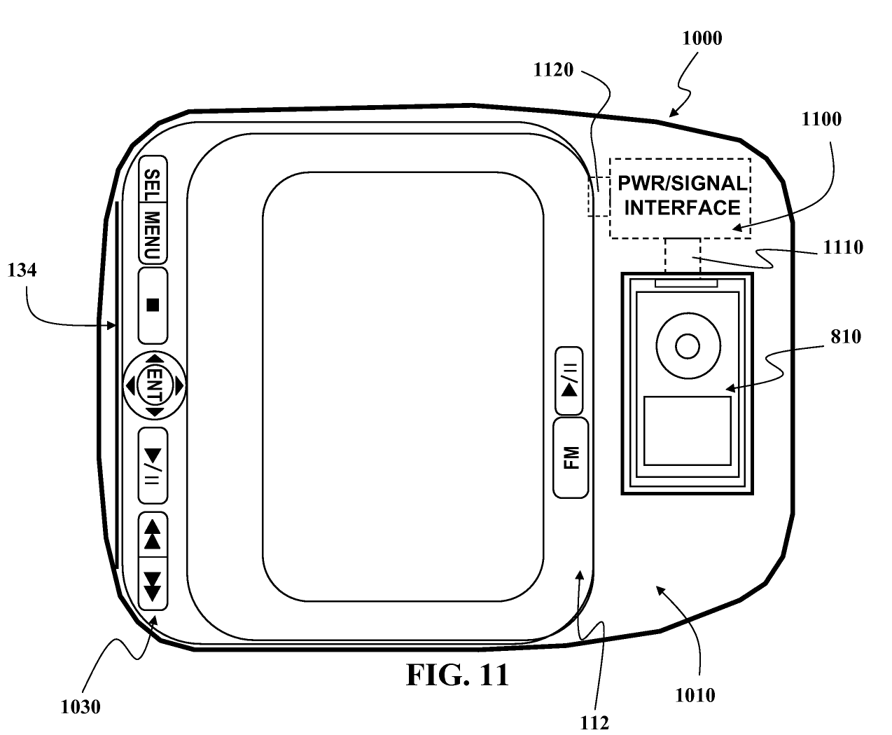

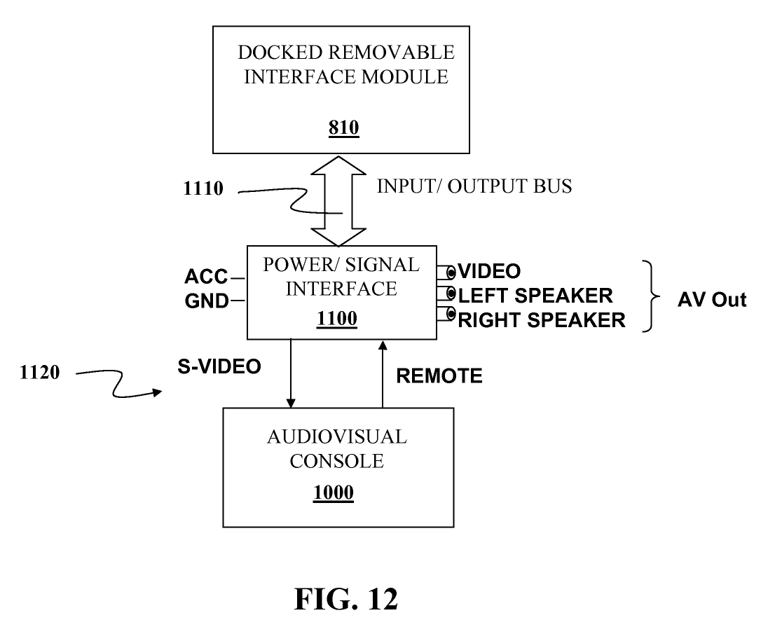

Illustrated in a plan view in FIG. 11 is a diagram of an exemplary power and signal interface 1100 to which a docked removable interface module may be operably connected and to which a DVD audiovisual console 1030 may be operably connected 1120. Illustrated in a schematic in FIG. 12 is an exemplary power/signal interface 1100 interposed between a docked removable interface module 810 and an audiovisual console 1000. The exemplary power/signal interface 1100 may provide video, particularly s-video to the audiovisual console 1000 and may in combination or separately may provide composite video and component video. The exemplary power/signal interface 1100 may receive control signals from the audiovisual console 1000 that may include control signals originating from the second user interface 142 (FIGS. 1 and 2) of a remote control, or for example, the first user interface 132 (not shown in FIG. 10) of the audiovisual console. FIG. 12 shows the power/signal interface 1100 may be powered by an accessory line (ACC) and grounded (GND). Also shown in FIG. 12 is the power/signal interface 1100 an optional set of audiovisual outputs, e.g., video, and two audio channels (i.e., left speaker, right speaker). The remote control unit 140 (FIGS. 1 and 2) may be used to control the removable interface module 810. The audiovisual console 1000 may receive command signals, for example, optical, infrared, RF, or wired or wireless signal from a remote control unit 140 and may provide the received command signals from the remote to the removable interface module 810 via the power/signal interface 1100. The power/signal interface 1100 may also output audio and video signals as received from the removable interface module 810 via the input/output bus 1110.

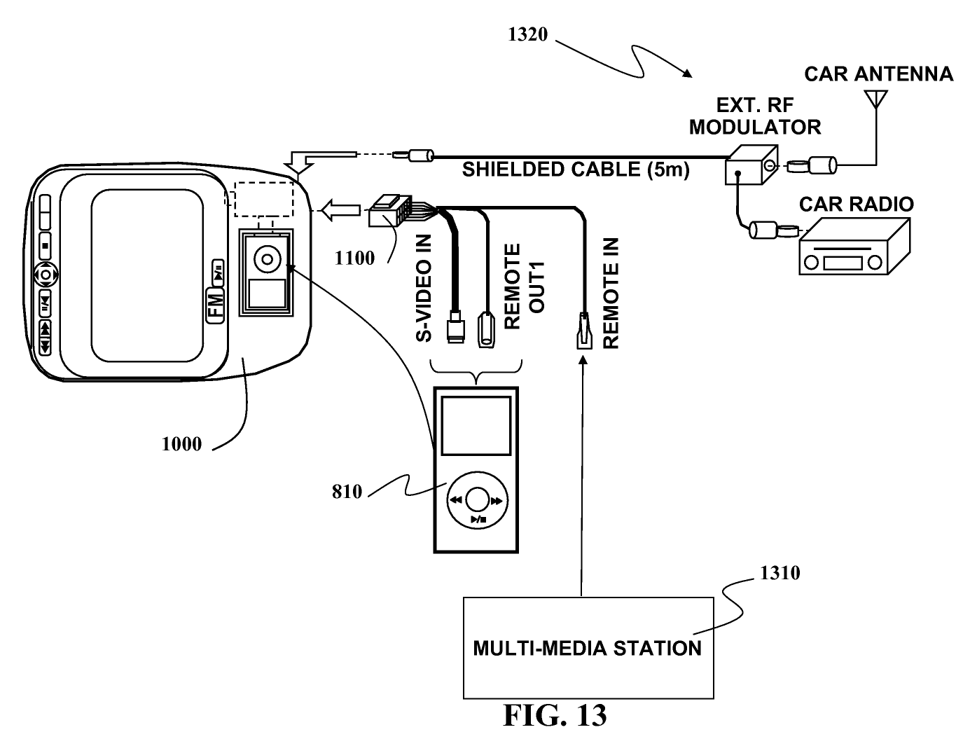

FIG. 13 illustrates in schematic view an exemplary system configuration according to an embodiment of the invention. In this exemplary embodiment, a multi-media system includes an audiovisual console 1000 interfacing with an interfacing module 1100. This exemplary system may receive, via a power/signal interface 1100, remote command inputs from a multi-media station 1310 which may direct, as remote out, the selection of files and files folders of the removable interface module 810. In addition, audio devices, such as an automobile radio system 1320 may be operably connected to the exemplary audiovisual console 1000.

Although this invention has been disclosed in the context of certain embodiments and examples, it will be understood by those or ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Furthermore, the processes described herein may be embodied in hardware, in a set of program instructions—software, or both, i.e., firmware. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

I claim:

1. A device, for a vehicle, comprising:
a control user interface comprising
a display adapted to display a first list of audiovisual elements; and
one or more effectors adapted to receive one or more user input to generate a second list of audiovisual elements comprising one or more audiovisual elements from the first list;
a play user interface comprising one or more input effectors adapted to receive a selection to play an audiovisual element from the second list; and
a presentation device adapted to play the selected audiovisual element;
wherein the control user interface and the play user interface are operably connected with each other.

2. The device of claim 1 wherein the control user interface is a removable user interface; and
wherein the device further comprises a cradle adapted to receive the removable control user interface.

3. The device of claim 2 wherein the removable control user interface further comprises a data store; and
wherein the first list of audiovisual elements is based on audiovisual elements stored in the data store.

4. The device of claim 1 further comprising:
an external input port;
wherein the control user interface further interfaces with an external data store via the external input port; and
wherein the first list of audiovisual elements is based on audiovisual elements stored in the external data store.

5. The device of claim 1 wherein the one or more effectors of the control user interface comprises a four-way wheel pushbutton with an enter pushbutton.

6. The device of claim 1 wherein the presentation device is further adapted to display the second list.

7. The device of claim 1 wherein the second list of audiovisual elements comprises at least one file folder comprising one or more audiovisual elements.

8. The device of claim 1 further comprising:
an interface adapted to receive at least one data store; and
wherein the first list of audiovisual elements is based on audiovisual elements stored in the at least one data store.

9. The device of claim 1 further comprising:
a remote user interface comprising one or more effectors adapted to support the functions of at least one of the following:
the control user interface; and
the play user interface.

10. The device of claim 1 wherein the display of the control user interface is adapted to display the first list of audiovisual elements within one or more play list folders.

11. The device of claim 1 wherein the one or more effectors of the control user interface is adapted to receive an override input of the selection to play the audiovisual element received by the play user interface.

12. The device of claim 1 wherein the second list of elements is a default list comprising one or more selection enabled play list folders.

13. The device of claim 1 further comprising:
an interface adapted to receive at least one data store;
wherein the play user interface, the presentation device, and the interface are integrated into an audiovisual play console.

14. The device of claim 13 wherein the audiovisual play console is a DVD player.

15. The device of claim 1 wherein the first list of audiovisual elements is based on an internal data store operably connected with the control user interface and an external data store.

16. A system comprising:
a vehicle; and
a device comprising:
a control user interface comprising
a display adapted to display a first list of audiovisual elements; and
one or more effectors adapted to receive one or more user input to generate a second list of audiovisual elements comprising one or more audiovisual elements from the first list;
a play user interface comprising one or more input effectors adapted to receive a selection to play an audiovisual element from the second list; and
a presentation device adapted to play the selected audiovisual element;
wherein the control user interface and the play user interface are operably connected with each other; and
wherein the device is mounted in an interior of the vehicle.

17. The system of claim 16 wherein the control user interface of the device is a removable user interface; and wherein the device further comprises a cradle adapted to receive the removable control user interface.

18. The system of claim 17 wherein the removable control user interface of the device further comprises a data store; and
wherein the first list of audiovisual elements is based on audiovisual elements stored in the data store.

19. The system of claim 16 wherein the display of the control user interface of the device is adapted to display the first list of audiovisual elements within one or more play list folders.

20. The system of claim 16 wherein the one or more effectors of the control user interface of the device is adapted to receive an override input of the selection to play the audiovisual element received by the play user interface.
